(19) United States
(12) Patent Application Publication
(10) Pub. No.: US 2004/0197518 A1
(43) Pub. Date: Oct. 7, 2004

(54) Antiferro coupled (AFC) media using CR based alloy space layer

(76) Inventors: Sooyoul Hong, Santa Clara, CA (US); Sechung Oh, Taejeon (KR); Taedong Lee, Seoul (KR); Hyung Jai Lee, Cupertino, CA (US); Kyungho Shin, Seoul (KR)

Correspondence Address: IRELL & MANELLA LLP, 840 NEWPORT CENTER DRIVE, SUITE 400, NEWPORT BEACH, CA, 92660, US

(21) Appl. No.: 10/405,585

(22) Filed: Apr. 1, 2003

(51) Int. Cl. B32B 3/02

(52) U.S. Cl. 428/65.3; 428/694 TM; 428/694 TP

(57) ABSTRACT

A disk for a hard disk drive. The disk includes a layer of chromium located between a top magnetic layer and an underlying stabilizing magnetic layer. The chromium diffuses into the top layer of magnetic material to magnetically decouple the grains of the magnetic material. Decoupling the grains of the magnetic material reduces the magnetic noise of the disk and improves the signal to noise ratio of the hard disk drive.

### BACKGROUND OF THE INVENTION

1. Field of the Invention

The subject matter disclosed generally relates to the field of hard disk drives.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a flexure arm to create an subassembly commonly referred to as a head gimbal assembly (“HGA”). The HGA's are attached to an actuator arm that has a voice coil coupled to a magnet assembly. The voice coil and magnet assembly create a voice coil motor that can pivot the actuator arm and move the heads across the disks.

Information is typically stored within annular tracks that extend across each surface of a disk. The voice coil motor can move the heads to different track locations to access data stored onto the disk surfaces. Each track is typically divided into a plurality of adjacent sectors. Each sector may have one or more data fields. Each data field has a series of magnetic transitions that are decoded into binary data. The spacing between transitions define the bit density of the disk drive. It is generally desirable to provide a high bit density to increase the overall storage capacity of the drive.

FIG. 1 schematically shows the layer of a disk 1 that is commonly referred to as an anti-ferromagnetic (AFC) media. The AFC media includes a stabilizing magnetic layer 2 located over a substrate 3. The stabilizing layer 2 and substrate 3 are typically separated by an underlayer 4 that strengthens the adhesion of the stabilizing material.

The stabilizing magnetic layer 2 is covered with a layer of ruthenium 5 and a top layer of magnetic material 6. The top magnetic layer 6 is protected with an overcoat layer 7, typically a diamond-like-carbon (DLC). The overcoat layer 7 may be covered with a layer of lubricant 8 to minimize any frictional contact between the head and the disk.

AFC media with a layer of ruthenium have been found to have a low thermal decay rate at high density recording. It is desirable to have a low decay rate to provide a stable media. Although it has a lower thermal decay rate, AFC media with a layer of ruthenium has a signal to noise ratio (SNR) that limits the bit density of the hard disk drive. To increase the bit density of the disk drive it is desirable to increase the signal to noise ratio of the disk while maintaining disk thermal stability.

### BRIEF SUMMARY OF THE INVENTION

A disk for a hard disk drive. The disk includes a layer of chromium located adjacent to a top layer of magnetic material and an underlying stabilizing magnetic layer.

### BRIEF DESCRIPTION OF THE DRAWINGS

FIG. 1 is an illustration showing the various layers of a disk of the prior art;

FIG. 2 is a top view of a hard disk drive;

FIG. 3 is an illustration showing various layers of a disk of the hard disk drive.

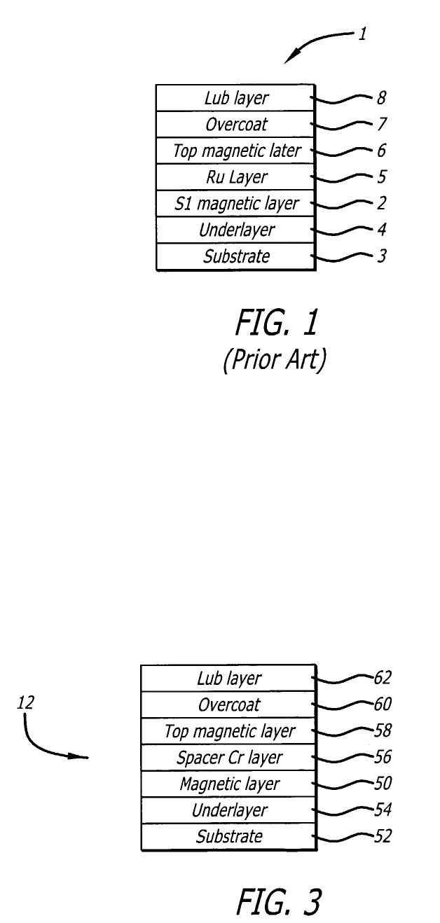

### DETAILED DESCRIPTION

Disclosed is a disk for a hard disk drive. The disk includes a layer of chromium located between a top magnetic layer and an underlying stabilizing magnetic layer. The chromium diffuses into the top layer of magnetic material to magnetically decouple the grains of the magnetic material. Decoupling the grains of the magnetic material reduces the magnetic noise of the disk and improves the signal to noise ratio of the hard disk drive.

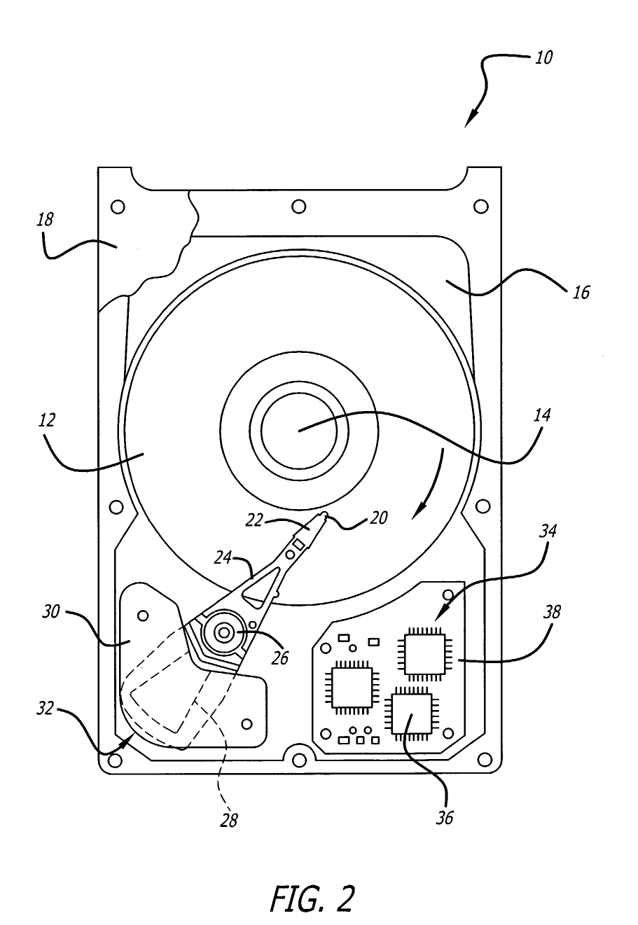

Referring to the drawings more particularly by reference numbers, FIG. 2 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

Each head 20 has an air bearing surface (not shown) that cooperates with an air flow created by the rotating disks 12 to generate an air bearing. The air bearing separates the head 20 from the disk surface to minimize contact and wear. The formation of the air bearing and the general operation of the head 20 is a function of a force exerted by the flexure arm 22.

The hard disk drive 10 may include a printed circuit board assembly 34 that includes a plurality of integrated circuits 36 coupled to a printed circuit board 38. The printed circuit board 38 is coupled to the voice coil 28, heads 20 and spindle motor 14 by wires (not shown).

FIG. 3 shows an embodiment of the disk 12. The disk 12 may include an stabilizing layer of magnetic material 50 that is located over a substrate 52. An underlayer 54 may be interposed between the substrate 52 and the stabilizing layer 50 to improve the adhesion of the stabilizing material. The substrate 52 may be constructed from an aluminum material. The stabilizing layer 50 may be a cobalt based ferromagnetic material that also contains chromium and platinum.

The stabilizing layer 50 is covered with a spacer layer of chromium 56. The chromium 56 is covered with a top layer of magnetic material 58. The top layer 58 may be a cobalt based ferromagnetic material that is the same or similar to the material of the stabilizing layer 50.

By way of example, the layer of chromium 56 may have a thickness ranging from 1.0 to 1.5 nanometers.

The chromium diffuses into the top magnetic layer 58 between the grains of the magnetic material. The diffused chromium reduces the magnetic coupling between the grains of the magnetic layer. Decreasing the magnetic coupling of the grains reduces the magnetic noise within the disk. The lower magnetic noise increases the signal to noise ratio of the hard disk drive. The diffused chromium also improves the thermal stability of the disk by increasing the effective grain volume of the magnetic layer 58.

The disk 12 may include an overcoat layer 60 that protects the underlying magnetic layers. By way of example, the overcoat layer 60 may be a diamond-like-carbon (DLC) material that is extremely hard. To reduce friction between the head and the disk, the outer disk surface may include a layer of lubricant 62.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A magnetic disk for a hard disk drive, comprising:
a substrate;
a stabilizing magnetic layer located over said substrate;
a top magnetic layer located over said substrate; and
a layer of chromium located between said magnetic layers, at least a portion of said chromium diffuses into said top magnetic layer to reduce magnetic coupling of grains within said top magnetic layer.

2. The disk of claim 1, further comprising an underlayer located between said substrate and said stabilizing magnetic layer.

3. The disk of claim 1, further comprising an overcoat layer located over said top magnetic layer.

4. The disk of claim 3, further comprising a layer of lubricant located over said overcoat layer.

5. A hard disk drive, comprising:
a base plate;
a spindle motor coupled to said base plate;
a disk coupled to said spindle motor, said disk including;
a substrate;
a stabilizing magnetic layer located over said substrate;
a top magnetic layer located over said substrate;
a layer of chromium located between said magnetic layers, at least a portion of said chromium diffuses into said top magnetic layer to reduce magnetic coupling of grains within said top magnetic layer
an actuator arm mounted to said base plate;
a voice coil motor coupled to said actuator arm;
a flexure arm coupled to said actuator arm; and,
a head coupled to said flexure arm and said disk.

6. The hard disk drive of claim 5, further comprising an underlayer located between said substrate and said stabilizing magnetic layer.

7. The hard disk drive of claim 5, further comprising an overcoat layer located over said top magnetic layer.

8. The hard disk drive of claim 7, further comprising a layer of lubricant located over said overcoat layer.

9. A method for fabricating a disk of a hard disk drive, comprising:
forming a layer of stabilizing magnetic material over a substrate;
forming a layer of chromium over the layer of stabilizing material; and,
forming a top layer of magnetic material onto the layer of chromium, at least a portion of the chromium diffusing into the top layer of magnetic material to reduce magnetic coupling of grains within the top layer of magnetic material.

10. The method of claim 9, further comprising forming an underlayer between the substrate and the layer of stabilizing magnetic material.

11. The method of claim 9, further comprising forming an overcoat layer onto the top layer of magnetic material.

12. The method of claim 11, further comprising forming a layer of lubricant onto the overcoat layer.

13. The disk of claim 1, wherein said layer of chromium has a thickness 1.0 to 1.5 nanometers.

14. The hard disk drive of claim 5, wherein said layer of chromium has a thickness between 1.0 to 1.5 nanometers.

15. The method of claim 9, wherein the layer of chromium has a thickness between 1.0 to 1.5 nanometers.
